(19) United States
(12) Patent Application Publication
(10) Pub. No.: US 2008/0205646 A1
(43) Pub. Date: Aug. 28, 2008

(54) COMPUTER-READABLE RECORDING MEDIUM STORING DATA DECRYPTION PROGRAM, DATA DECRYPTION METHOD, AND DATA DECRYPTION DEVICE

(75) Inventors: Hiroyuki KOMORI, Kawasaki (JP); Jun Yajima, Kawasaki (JP); Tetsuhiro Kodama, Kawasaki (JP); Kouta Soejima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/036,711

(22) Filed: Feb. 25, 2008

(30) Foreign Application Priority Data
Feb. 23, 2007 (JP) JP2007-043963

(51) Int. Cl. H04L 9/06

(52) U.S. Cl. 380/255

(57) ABSTRACT

A method, device and computer-readable recording medium that stores therein a computer program for data decryption to execute processing when encrypted communication data including encrypted data obtained by encrypting plain text data and communication attributive data representing information of a data size of communicated data is received, the computer program making a computer execute notifying for receiving only the communication attributive data in the encrypted communication data and notifying the data size represented by the received communication attributive data to a preparing unit which prepares a storage area for storing the encrypted communication data in temporary storage incorporated in the computer. The computer program also enables the computer to execute storing the encrypted communication data in the prepared storage area and decrypting the encrypted data contained in the encrypted communication data, which is stored in the storage area, to obtain the plain text data.

### CROSS-REFERENCE TO RELATED APPLICATIONS

This application is related to and claims the benefit of priority from the prior Japanese Patent Application No. 2007-43963 filed on Feb. 23, 2007, the entire contents of which are incorporated herein by reference.

### BACKGROUND

1. Field of the Invention

The present invention relates to a computer-readable recording medium storing a data decryption program and a data decryption device.

2. Description of the Related Art

For the purpose of avoiding troubles suffered from third parties on networks, such as “tapping”, “tampering”, and “impersonation”, various kinds of encrypted communication schemes including, e.g., TLS (Transport Layer Security)/SSL (Secure Socket Layer) communication are known.

In the TLS/SSL communication, for example, not only authentication, but also negotiations necessary in an encryption scheme with a key are performed between a peer server-client. Then, original data (plain text data or source data) is encrypted and transferred by using the authenticated peer server-client and the negotiated encryption scheme and key.

FIG. 1 is a block diagram illustrating a conventional processing executed in encrypted communication.

In a system (interconnecting a server and a client) for the encrypted communication, it is generally known that an application (not shown) on the transmitting side 91 where original data 90 is encrypted utilizes a software library (not shown) for the encrypted communication. The software library includes a protocol stack installed therein. On the receiving side 92, encrypted data 94 is decrypted in a receiving buffer 93a, which is prepared by a software library 93, and the decrypted original data 90 is referred to by an application 95 on the receiving side.

The encrypted data 94 has a size increased from that of the original data 90, and an incremental amount of the data size is not constant. Accordingly, the data size of the original data 90 is not known until the encrypted data 94 is all received and decrypted. In other words, because the encrypted data 94 and the original data 90 differ in size from each other, it is impossible for the receiving side 92 to know the data size of the encrypted data 94 in advance. For that reason, the application 95 on the receiving side executes, in the software library 93, management of the receiving buffer 93a for receiving the data.

When the application 95 reads the original data 90, the application 95 prepares the address and the size of a data storage area 96 and specifies the prepared address and size to the software library 93. Further, the application 95 uses the original data 90 decrypted by the software library 93 after copying the decrypted original data into the data storage area 96 in amount corresponding to the specified size.

When the encrypted communication is performed in, e.g., an embedded device in which resources such as a CPU (Central Processing Unit) and a memory are restricted, it is desirable to reduce the number of times of copying performed. Further, because the size of data handled by the embedded device is limited or is not so large in some cases, the size of the receiving buffer prepared by the known software library may not be appropriate.

### SUMMARY

According to an embodiment, a computer-readable recording medium that stores therein a computer program for data decryption to execute processing when encrypted communication data including encrypted data obtained by encrypting plain text data and communication attributive data representing information of a data size of communicated data is received, the computer program enabling a computer to notifying data size for receiving only the communication attributive data in the encrypted communication data and notifying the data size represented by the received communication attributive data to a preparing unit which prepares a storage area for storing the encrypted communication data in temporary storage incorporated in the computer, storing the encrypted communication data in the prepared storage area, decrypting the encrypted data contained in the encrypted communication data, which is stored in the storage area, to obtain the plain text data.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating conventional processing executed in encrypted communication;

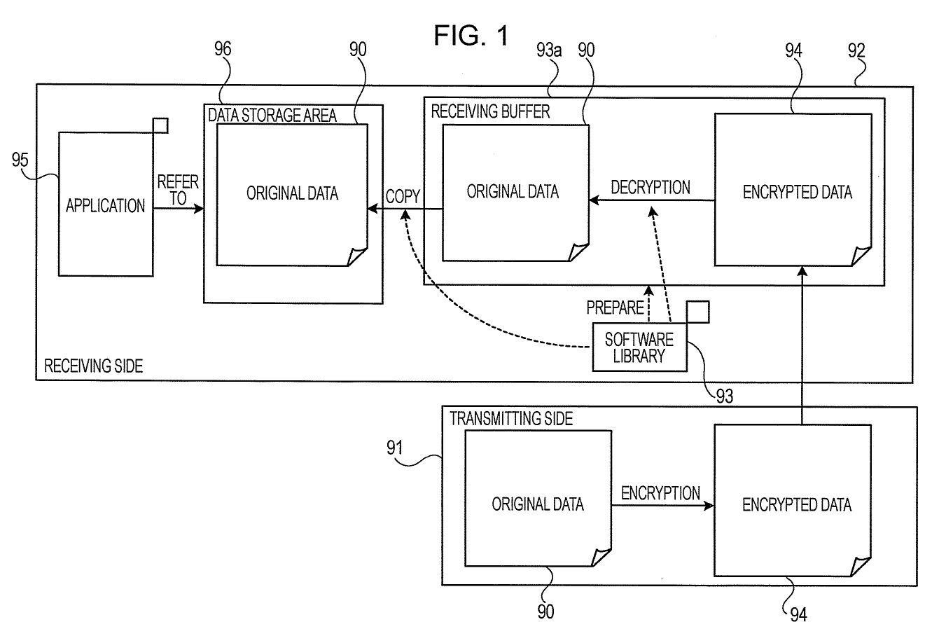

FIG. 2 is a block diagram illustrating an example receiving side device according to an embodiment;

FIG. 3 is a block diagram illustrating a system configuration according to an embodiment;

FIG. 4 is a block diagram illustrating encryption of communication data according to an embodiment;

FIG. 5 is a block diagram illustrating an example receiving side device according to an embodiment;

FIG. 6 is a block diagram illustrating a receiving side device according to an embodiment;

FIG. 7 is a block diagram illustrating a system according to an embodiment;

FIG. 8 is a flowchart illustrating an example method of processing executed on a receiving side according to an embodiment; and

FIG. 9 is a block diagram of a system according to an embodiment of another invention.

FIG. 10 is a flowchart illustrating an example method of processing executed on the receiving side according to an embodiment.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

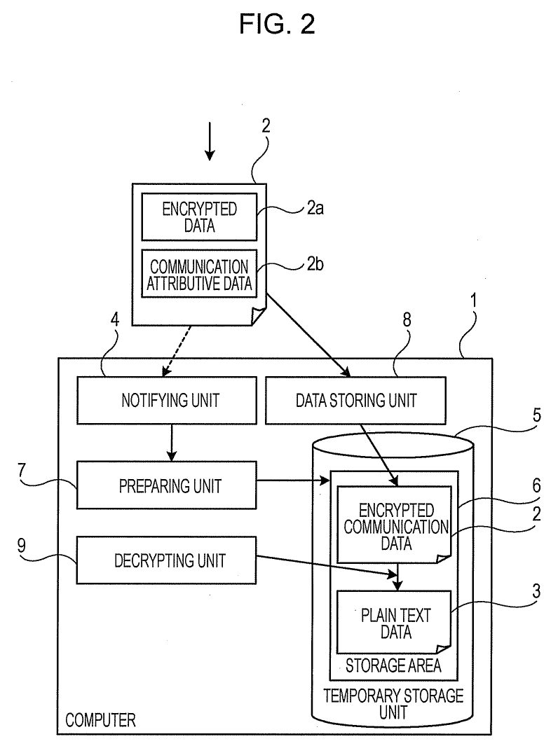

FIG. 2 is a block diagram illustrating a receiving side device according to an embodiment.

Encrypted communication data 2, shown in FIG. 2, can include encrypted data 2a prepared by encrypting plain text data 3, and communication attributive data 2b representing information about the data size of the encrypted communication data 2 (or the data size of the encrypted data 2a). The encrypted communication data 2 can be prepared by another computer (not shown) than a computer 1 and can be transmitted to the computer 1 via a network (not shown).

The computer 1 can include a notifying unit 4, a temporary storage unit 5, a preparing unit 7, a data storing unit 8, and a decrypting unit 9. Of those units, the notifying unit 4, the data storing unit 8, and the decrypting unit 9 can be provided by a data decryption program.

The notifying unit 4 receives only the communication attributive data 2b in the encrypted communication data 2 and notifies the data size represented by the received communication attributive data 2b to the preparing unit 7. The preparing unit 7 receives the notification from the notifying unit 4 and prepares, in the temporary storage unit 5 included in the computer 1, a storage area 6 for storing the encrypted communication data 2. In other words, the preparing unit 7 prepares the storage area 6 corresponding to the data size of the encrypted communication data 2.

The data storing unit 8 can store the encrypted communication data 2 in the prepared storage area 6.

The decrypting unit 9 decrypts the encrypted data 2a, which is included in the encrypted communication data 2 stored in the storage area 6, to thereby obtain the plain text data 3.

Thus, according to in executing an example data decryption program, the notifying unit 4 receives only the communication attributive data 2b in the encrypted communication data 2 and notifies the data size represented by the received communication attributive data 2b to the preparing unit 7. The preparing unit 7 prepares, in the temporary storage unit 5 included in the computer 1, the storage area 6 for storing the encrypted communication data 2, and the data storing unit 8 stores the encrypted communication data 2 in the prepared storage area 6. The decrypting unit 9 decrypts the encrypted data 2a, which is included in the encrypted communication data 2 stored in the storage area 6, to thereby obtain the plain text data 3.

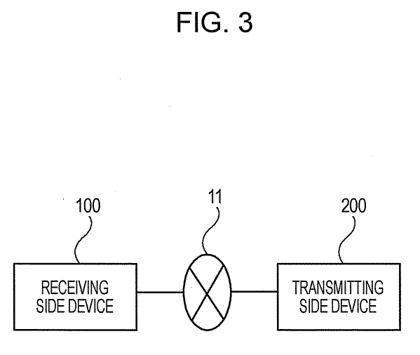

FIG. 3 is a block diagram illustrating a system configuration according to an embodiment.

In an encryption-decryption processing system, a receiving side device 100 and a transmitting side device 200 are connected to each other via a network 11.

The receiving side device 100 can include a user interface through which a data transmission command is sent to the transmitting side device 200 in accordance with, e.g., an input operation by the user. While the content of transmitted data differs depending on individual commands from the user, the data may be, for example, image data, audio data, and document data.

When the transmitting side device 200 receives the data transmission command from the receiving side device 100, it prepares the encrypted communication data that is transmitted to the receiving side device 100.

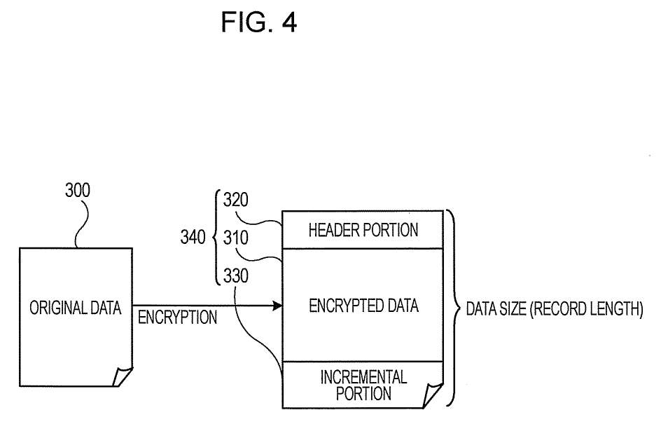

FIG. 4 is block diagram illustrating encryption of data according to an embodiment.

The transmitting side device 200 can encrypt data (original data) 300 that is not yet encrypted and is to be transmitted to the receiving side device 100, thereby preparing encrypted data 310. Further, the transmitting side device 200 can add, to the prepared encrypted data 310, a header portion 320 having a fixed length and an incremental portion 330 depending on the encrypted communication scheme, thereby preparing encrypted communication data 340.

The header portion 320 can contain information that represents the data size (record length) of the encrypted communication data 340.

The incremental portion 330 can have a variable length and include padding, etc.

The header portion 320 is the communication attributive data, and both the encrypted data 310 and the incremental portion 330 are an encrypted data portion.

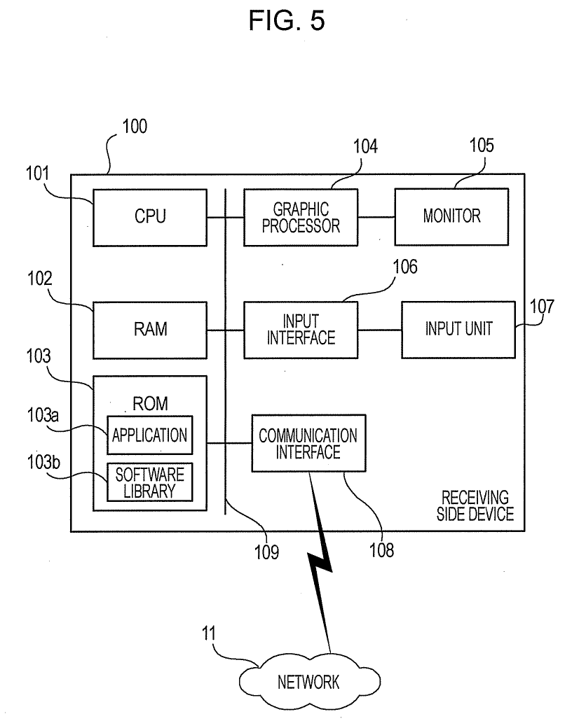

FIG. 5 is a block diagram illustrating an example of a receiving side device.

The entirety of the receiving side device 100 can be controlled by a CPU 101. A RAM (Random Access Memory) 102, a ROM (Read Only Memory) 103, a graphic processor 104, an input interface 106, and a communication interface 108 can be connected to the CPU 101 via a bus 109.

The RAM 102 can temporarily store at least part of programs for an OS (Operating System) and application programs which are executed by the CPU 101. Also, the RAM 102 can stores various kinds of data necessary for the processing executed by the CPU 101.

The ROM 103 can store various kinds of programs such as the OS, applications 103a, and a software library 103b.

A monitor 105 can be connected to the graphic processor 104. The graphic processor 104 displays an image on a screen of the monitor 105 in accordance with an instruction from the CPU 101. An input unit 107, including an arrow key and other buttons, can be connected to the input interface 106. The input interface 106 transmits a signal sent from the input unit 107 to the CPU 101 via the bus 109.

The communication interface 108 can be connected to the network 11. The communication interface 108 transmits and receives data to and from the transmitting side device 200 via the network 11.

The processing of an embodiment can be realized with the above-described hardware configuration. While an embodiment has been described above as employing the receiving side device 100 that includes the monitor 105 and the input unit 107, the present invention is not limited to the illustrated configuration of an embodiment. For example, the receiving side device 100 may be connectable to a monitor and an input unit that are externally disposed. In order to execute a data decryption process in the system having the above-described hardware configuration, the receiving side device 100 can include the following functions.

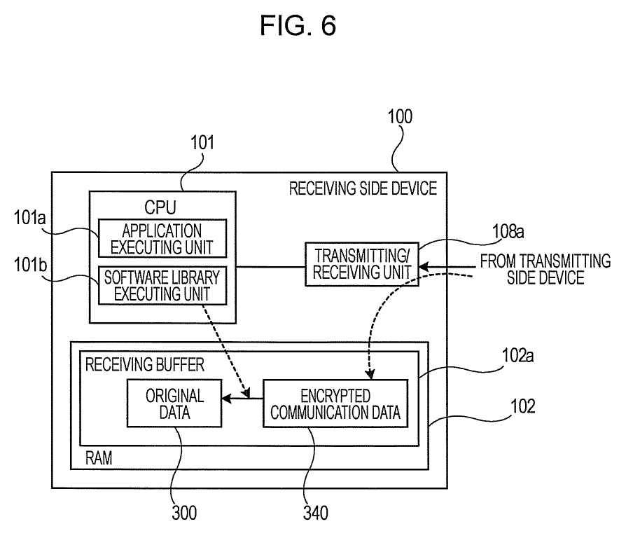

FIG. 6 is a block diagram illustrating an example receiving side device according to an embodiment.

The receiving side device 100 includes an application executing unit 101a and a software library executing unit 101b that can be as a function of the CPU 101, a receiving buffer 102a prepared in the RAM 102, and a transmitting/receiving unit 108a that can be realized with as a function of the communication interface 108.

The application executing unit 101a can be started when it receives the encrypted communication data 340 from the transmitting side device 200, for example, in response to a command for downloading which can be sent to the transmitting side device 200 from the input unit 107. Then, the application executing unit 101a can read out the application 103a from the ROM 103 and executes it.

The application executing unit 101a prepares the receiving buffer 102a, which can have a predetermined address and size, in the RAM 102 when the application 103a is executed.

The software library executing unit 101b can read out the software library 103b from the ROM 103 and executes it when the application executing unit 101a is started up.

The software library executing unit 101b notifies the data size of the encrypted communication data 340, which has been received by the transmitting/receiving unit 108a, to the application executing unit 101a.

Further, the software library executing unit 101b decrypts the encrypted communication data 340 in the receiving buffer 102a to obtain the original data 300.

The transmitting/receiving unit 108a can include an interface with respect to the transmitting side device 200.

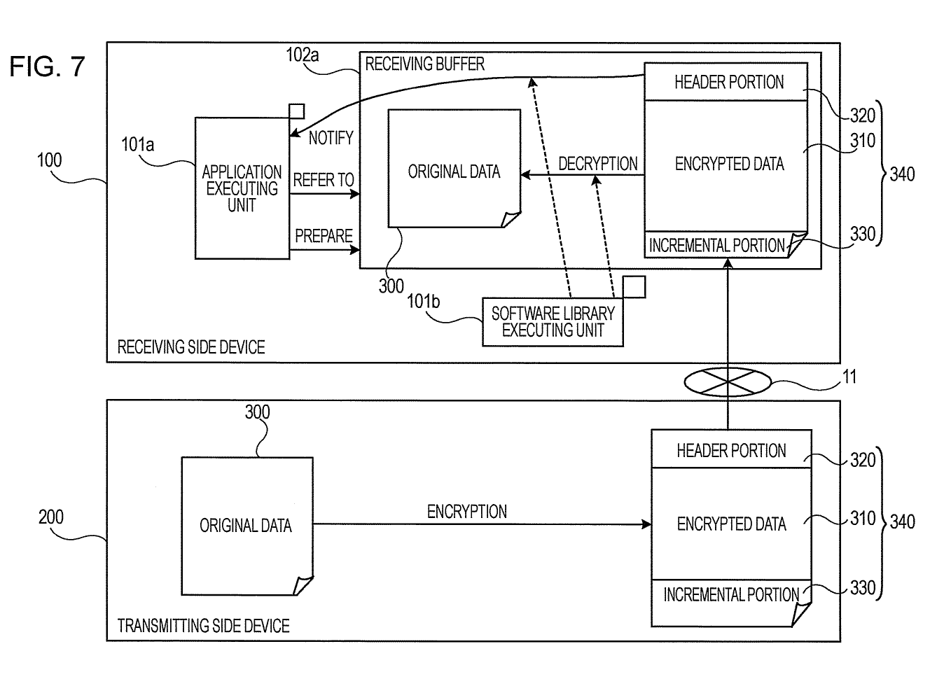

FIG. 7 is a block diagram illustrating a system according to an embodiment.

The receiving side device 100 can send, to the transmitting side device 200, the command for transmission of data to the receiving side device 100, and the application executing unit 101a and the software library executing unit 101b are started.

The transmitting side device 200 receives the data transmission command and can encrypts the original data 300 to prepare the encrypted communication data 340.

Then, the transmitting side device 200 can transmit the encrypted communication data 340 to the receiving side device 100 via the network 11.

In the receiving side device 100 having received the encrypted communication data 340, the application executing unit 101a prepares, in the RAM 102, the receiving buffer 102a corresponding to the data size of the encrypted communication data 340, which has been notified from the software library executing unit 101b.

The software library executing unit 101b can directly receive the encrypted communication data 340 in the receiving buffer 102a prepared by the application executing unit 101a. Further, the software library executing unit 101b decrypts the encrypted communication data 340 in the receiving buffer 102a to obtain the original data 300. The application executing unit 101a refers to and reads out the decrypted original data 300.

Processing on the receiving side can include processing executed by the application executing unit 101a and the software library executing unit 101b in order that the receiving side device 100 receives the encrypted communication data 340 and decrypts it into the original data 300.

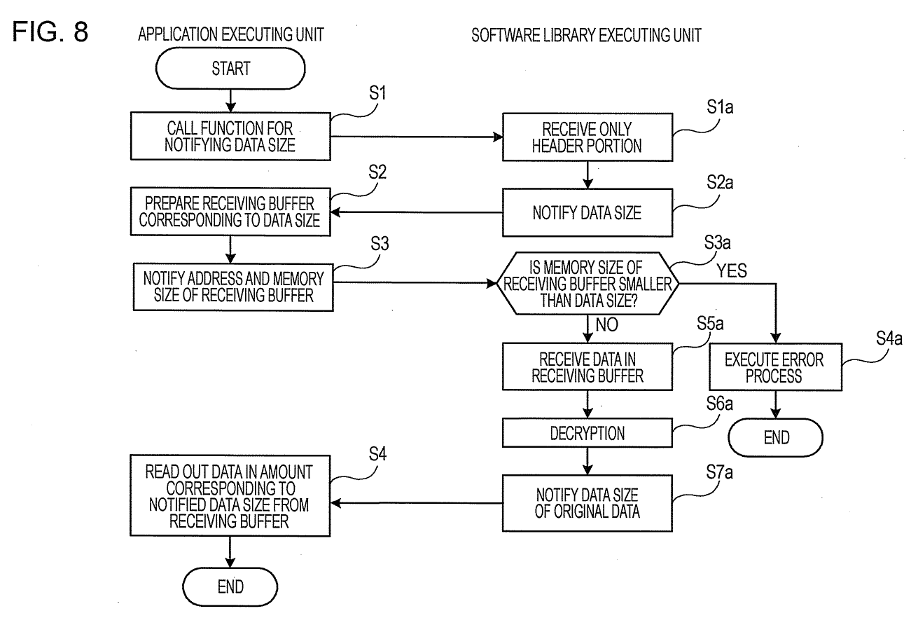

FIG. 8 is a flowchart illustrating a method of processing executed on the receiving side according to an embodiment.

When the receiving side device 100 receives the encrypted communication data 340, the application executing unit 101a can call a function for notifying the data size (operation S1).

With the calling of the function, the software library executing unit 101b receives only the header portion 320 in the encrypted communication data 340 (operation S1a).

Then, the data size is taken out from the header portion 320 and referred to, by the software library executing unit 101b and notifies the data size to the application executing unit 101a (operation S2a).

Upon receiving the data size, the application executing unit 101a, prepares the receiving buffer 102a, which has a memory size corresponding to the received data size, in the RAM 102 (operation S2).

Then, the application executing unit 101a, notifies the address and the memory size of the prepared receiving buffer 102a to the software library executing unit 101b (operation S3).

Based on the received data size, the software library executing unit 101b can determine whether the memory size of the receiving buffer 102a is smaller than the received data size (i.e., whether the receiving buffer 102a having the memory size enough to receive the encrypted communication data 340 can be prepared by the application executing unit 101a) (operation S3a).

If the memory size of the receiving buffer 102a is smaller than the received data size (i.e., Yes in operation S3a), null reception can be executed as an error process (operation S4a). The receiving side process can then be brought to an end. The received date is abandoned in null reception.

If the memory size of the receiving buffer 102a is equal to or greater than the received data size (i.e., No in operation S3a), the software library executing unit 101b receives the encrypted communication data 340 in the receiving buffer 102a that has been prepared by the application executing unit 101a (operation S5a).

The software library executing unit 101b can execute decryption of the encrypted communication data 340 (operation S6a).

Thereafter, the software library executing unit 101b notifies the data size of the original data 300, which has been obtained by the decryption, to the application executing unit 101a (operation S7a).

The application executing unit 101a reads out the original data 300 in amount corresponding to the notified data size from the receiving buffer 102a (operation S4).

The processing on the receiving side is thereby completed.

With the system operations according to an embodiment, since the software library executing unit 101b first receives only the header portion 320 to refer to the data size and notifies the data size to the application executing unit 101a, the application executing unit 101a can prepare the receiving buffer 102a with the memory size corresponding to the data size. Therefore, the receiving buffer 102a can be prepared without causing a loss in use of its memory capacity. Also, since the software library executing unit 101b decrypts the encrypted communication data 340 in the receiving buffer 102a to obtain the original data 300, the application executing unit 101a is not required to prepare an additional separate area for obtaining the original data 300. Therefore, the number of times of data copying can be reduced and the processing time can be reduced. Further, it is possible to reduce not only the memory size actually used, but also the memory capacity to be prepared. As a result, a significant advantage is obtained particularly when an embodiment is applied to an embedded device.

An encryption-decryption processing system according to another embodiment is disclosed with descriptions of similar points are omitted here.

The system according to an embodiment can be used when the maximum data size of the original data 300 can be estimated in advance for such reason that some restriction is imposed on the data size of the original data 300.

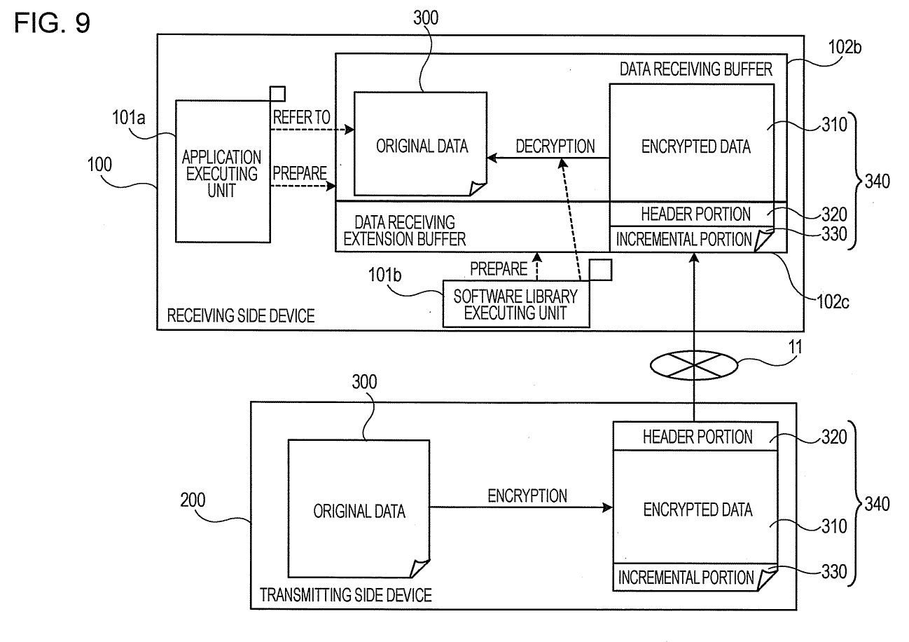

FIG. 9 is a block diagram for explaining system operations according to another embodiment.

In an embodiment, information (e.g., about 1 kB) representing the data size of the original data 300 can be previously stored in the application executing unit 101a.

Based on that information, the application executing unit 101a can prepare a data receiving buffer (first storage area) 102b (with a memory size corresponding to the maximum length of the original data 300).

Also, the software library executing unit 101b previously stores information representing a maximum size (corresponding to the size of a second storage area 102c) to which the size of the encrypted communication data 340 can be maximally increased in comparison with the size of the original data 300. Such a maximum size can be determined, for example, from known values including the length of the header portion, the maximum length of padding, the length of MAC, etc. It is to be noted that because those values are specified depending on the encryption scheme, they can be managed by the software library executing unit 101b.

The memory size of the data receiving extension buffer 102c serving as the second storage area can be held at the least necessary value so long as it is able to store the header portion 320 and the incremental portion 330. For example, the memory size of the data receiving extension buffer 102c can be about 0.3 kB.

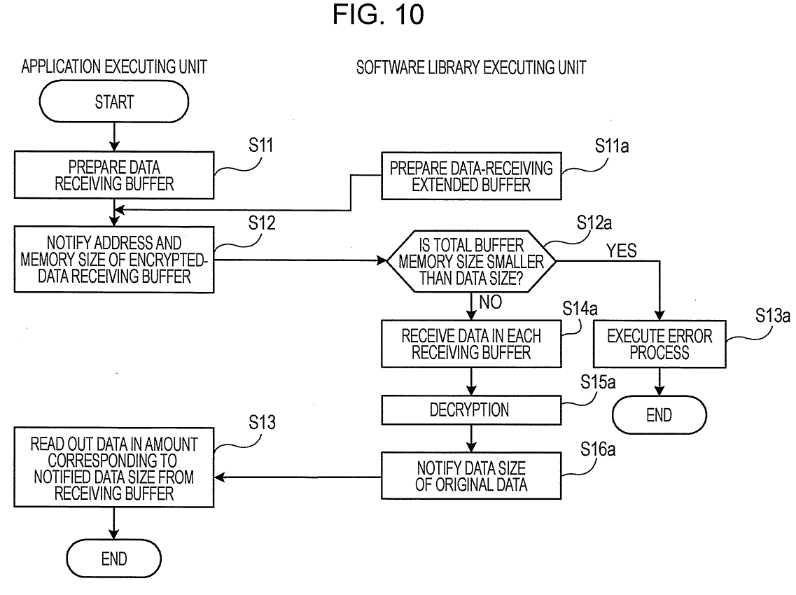

FIG. 10 is a flowchart showing an example processing method executed on the receiving side according to an embodiment.

When the receiving side device 100 receives the encrypted communication data 340, the application executing unit 101a prepares the data receiving buffer 102b (operation S11).

Also, the software library executing unit 101b prepares the data receiving extension buffer 102c (operation S11a), and the software library executing unit 101b waits for a notification from the application executing unit 101a.

The application executing unit 101a notifies the address and the memory size of the prepared data receiving buffer 102b to the software library executing unit 101b (operation S12).

The software library executing unit 101b determines whether a total of the memory size of the prepared data receiving buffer 102b and the memory size of the prepared data receiving extension buffer 102c can be smaller than the received data size (i.e., whether the data receiving buffer 102b and the prepared data receiving extension buffer 102c both having the memory size enough to receive the encrypted communication data 340 is prepared respectively by the application executing unit 101a and the software library executing unit 101b) (operation S12a).

If the total buffer memory size is smaller than the received data size (i.e., Yes in operation S12a), null reception is executed as an error process (operation S13a). The receiving side process is then brought to an end.

If the total buffer memory size is equal to or greater than the received data size (i.e., No in operation S12a), the software library executing unit 101b receives and stores the encrypted communication data 340 in both the data receiving buffer 102b and the data receiving extension buffer 102c, which have been prepared respectively by the application executing unit 101a and the software library executing unit 101b (operation S14a). When the data size of the encrypted communication data 340 is small, the encrypted communication data 340 can be stored only in the data receiving buffer 102b in some cases.

The software library executing unit 101b executes decryption of the encrypted communication data 340 (operation S15a).

Thereafter, the software library executing unit 101b notifies the data size of the original data 300, which has been obtained by the decryption, to the application executing unit 101a (operation S16a).

The application executing unit 101a refers to and reads out the original data 300 in amount corresponding to the notified data size from the data receiving buffer 102b (operation S13).

The processing on the receiving side according to an embodiment is thereby completed.

With the system operations according to an embodiment, since the software library executing unit 101b can prepare the data receiving extension buffer 102c, the application executing unit 101a can prepare the data receiving buffer 102b without considering how much the data size is possibly increased by the encryption. Therefore, similar advantages can be obtained as those previously disclosed.

The data decryption programs used in example embodiments can be realized by adding interfaces (functions) to the existing program. The functions can be provided to implement an example embodiment. Function 1 can be executed by the software library executing unit 101b in an example system of an embodiment. Function 2 can be executed by the software library executing unit 101b in example the embodiments. Function 3 can be executed by the software library executing unit 101b in another embodiment.

### <Function 1>

Summary: Function 1 serves to notify the data size of the received encrypted communication data to the application in advance.

Interface: size=f(void)

Size: data size of the encrypted communication data

Functional ability: With Function 1, the software library executing unit 101b receives the header portion of a record, which is the communication attributive data, and notifies the data size stored in the header portion (or calculated from information therein).

### <Function 2>

Summary: Function 2 serves to notify the address and the memory size of the receiving buffer, which has been prepared by the application, to the software library. Further, it serves to notify the data size of the decrypted original data to the application.

Interface: size2=f(address, size1)

Address: address of the receiving buffer prepared by the application

Herein, “size1” represents the memory size of the receiving buffer prepared by the application, and “size2” represents the data size of the decrypted data (original data).

Functional ability: With Function 2, the software library executing unit 101b receives the data by using the receiving buffer prepared by the application, and then decrypts the received data. If “size1” is smaller than the data size notified by Function 1, the error process (null reception of data) is executed. Further, the software library executing unit 101b notifies the data size of the decrypted data (original data) to the application.

### <Function 3>

Summary: Function 3 serves to prepare the receiving buffer having a memory size corresponding to the estimated maximum data size of the original data, and to notify the address and the memory size of the prepared receiving buffer to the software library.

Interface: size2=f(address, size1)

Address: address of the receiving buffer prepared by the application

Herein, “size1” represents the memory size of the receiving buffer prepared by the application, and “size2” represents the data size of the decrypted data (original data).

Functional ability: With Function 3, the software library executing unit 101b receives the data by using both the receiving buffer prepared by the application and the receiving extension buffer, and then decrypts the received data. If the received data has a larger size than the total memory size of “size1” and the receiving extension buffer, the error process (null reception of data) is executed. Further, the software library executing unit 101b notifies the data size of the decrypted data (original data) to the application.

While example data decryption programs, methods, and data decryption systems according to example embodiments have been described above with reference to the drawings, the present invention is not limited to the illustrated examples. Individual components of each can be replaced with other components having similar functions. Further, other optional components and/or operations can be added or subtracted to the illustrated examples.

Also, an embodiment can be implemented by combining two or more of the elements (features) in the above-described embodiments.

Further, the embodiments can be applied to various secure fields including, e.g., industrial equipment and home networks.

The encryption scheme usable in the disclosed embodiments are not limited to the example described herein

The above-described processing operations can be realized by using a computer. In such a case, a program describing the processing details of the function to be executed by the software library executing unit 101b is provided. By causing the computer to execute the provided program, the above-described processing functions are realized on the computer. The program describing the processing details can be recorded on a computer-readable recording medium. Examples of the computer-readable recording medium include a magnetic recording device, an optical disk, a magneto-optical recording medium, and a semiconductor memory. The magnetic recording device may be, e.g., a hard disk drive (HDD), a flexible disk (FD), or a magnetic tape. The optical disk may be, e.g., a DVD (Digital Versatile Disk), a DVD-RAM (Random Access Memory), a CD-ROM (Compact Disk Read Only Memory), a CD-R (Recordable)/RW (ReWritable). The magneto-optical recording medium may be, e.g., a MO (Magneto-Optical disk).

The program can be distributed to users in various ways. For example, portable recording media, such as DVDs or CD-ROMs, each recording the program thereon are put into the market. As an alternative, the program may be stored in a storage unit of a server computer and then transferred from the server computer to other computers via a network.

A computer for executing the data decryption program can store, in its own storage unit, the program that is, by way of example, recorded on a portable recording medium or transferred from the server computer. Further, the computer can read the program from its own storage unit and execute the processing in accordance with the program. As an alternative, the computer may read the program directly from the portable recording medium and execute the processing in accordance with the program.

Although a few embodiments have been shown and described, it would be appreciated by those skilled in the art that changes might be made in these embodiments without departing from the principles and spirit of the invention, the scope of which is defined in the claims and their equivalents.

What is claimed is:

1. A computer-readable recording medium that stores therein a computer program for data decryption to execute processing when encrypted communication data including encrypted data obtained by encrypting plain text data and communication attributive data representing information of a data size of communicated data is received, the computer program enabling a computer to execute:
receiving only the communication attributive data in the encrypted communication data and notifying the data size represented by the received communication attributive data to a preparing unit that prepares a storage area for storing the encrypted communication data in temporary storage unit incorporated in the computer;
storing the encrypted communication data in the prepared storage area; and
decrypting the encrypted data contained in the encrypted communication data, which is stored in the storage area, to obtain the plain text data.

2. The computer-readable recording medium according to claim 1, wherein the computer program further enables the computer to execute: notifying a size of the plain text data, which has been decrypted, to a plain text employing unit incorporated in the computer.

3. The computer-readable recording medium according to claim 1, wherein storing the encrypted communication data in the storage area when the storage area is compared in size with the encrypted communication data based on the data size represented by the received communication attributive data and the size of the storage area is equal to or greater than the size of the encrypted communication data.

4. The computer-readable recording medium according to claim 1, wherein the communication attributive data is contained in a header having a fixed length.

5. A computer-readable recording medium that stores therein a computer program for data decryption to execute processing when encrypted communication data including encrypted data obtained by encrypting plain text data and communication attributive data representing information of a data size of communicated data is received, the computer program enabling a computer to execute:
in addition to a first storage area that is prepared in temporary storage unit incorporated in the computer based on a previously determined size, preparing a second storage area for storing the data contained in the encrypted communication data;
storing the encrypted communication data in both the first storage area and the second storage area; and
decrypting the encrypted data contained in the encrypted communication data, which is stored in both the first storage area and the second storage area, to obtain the plain text data.

6. The computer-readable recording medium according to claim 5, wherein preparing the second storage area is based on known data size previously determined.

7. The computer-readable recording medium according to claim 5, wherein storing the encrypted communication data in both the first storage area and the second storage area when a total of the first storage area and the second storage area is compared in size with the encrypted communication data and the total size of both the storage areas is equal to or greater than the size of the encrypted communication data.

8. A data decryption device for executing processing when encrypted communication data including encrypted data obtained by encrypting plain text data and communication attributive data representing information of a data size of communicated data is received, the data decryption device comprising:
a notifying unit for receiving only the communication attributive data in the encrypted communication data and notifying the data size represented by the received communication attributive data;
a preparing unit for, based on the data size notified from the notifying unit, preparing a storage area for storing the encrypted communication data in temporary storage unit incorporated in a computer;
a data storing unit for storing the encrypted communication data in the prepared storage area;
a decrypting unit for decrypting the encrypted data contained in the encrypted communication data, which is stored in the storage area, to obtain the plain text data; and
a taking-out unit for taking out the plain text data, which has been decrypted by the decrypting unit, from the storage area.

9. A method for data decryption to execute processing when encrypted communication data including encrypted data obtained by encrypting plain text data and communication attributive data representing information of a data size of communicated data is received, the method comprising:
receiving only the communication attributive data in the encrypted communication data and notifying the data size represented by the received communication attributive data to a preparing unit that prepares a storage area for storing the encrypted communication data in a temporary storage unit incorporated in the computer;
storing the encrypted communication data in the prepared storage area; and
decrypting the encrypted data contained in the encrypted communication data, which is stored in the storage area, to obtain the plain text data.

10. A method for data decryption to execute processing when encrypted communication data including encrypted data obtained by encrypting plain text data and communication attributive data representing information of a data size of communicated data is received, the method comprising:
in addition to a first storage area that is prepared in temporary storage unit incorporated in the computer based on a previously determined size, preparing a second storage area for storing the data contained in the encrypted communication data;
storing the encrypted communication data in both the first storage area and the second storage area; and
decrypting the encrypted data contained in the encrypted communication data, which is stored in both the first storage area and the second storage area, to obtain the plain text data.
